(19) United States
(12) Patent Application Publication
(10) Pub. No.: US 2009/0083365 A1
(43) Pub. Date: Mar. 26, 2009

(54) SYSTEM AND METHOD FOR NEIGHBORHOOD INFORMATION AND LOCAL SHOPPING OFFERS

(76) Inventor: Anthony Feldman, Flower Mound, TX (US)

Correspondence Address: MICHAEL A. O'NEIL, P.C., 5949 SHERRY LANE, SUITE 820, DALLAS, TX, 75225, US

(21) Appl. No.: 12/237,243

(22) Filed: Sep. 24, 2008

Related U.S. Application Data
(60) Provisional application No. 60/995,140, filed on Sep. 25, 2007.

(51) Int. Cl. G06F 17/30; G06F 15/16

(52) U.S. Cl. 709/201; 707/3; 707/E17.014

(57) ABSTRACT

A system for retrieval and display of proximity shopping and restaurant listings, advertising and local information to a plurality of users is disclosed. The users are provided with a portal display page which includes a plurality of independently functioning display modules. Each display module may be populated with a different type of information. The information provided in each module can be customized to the neighborhood or subdivision in which the user resides.

### CROSS-REFERENCE TO RELATED APPLICATION

Applicant claims priority based on provisional patent application Ser. No. 60/995,140, the entire contents of which is incorporated herein by reference.

### BRIEF DESCRIPTION OF THE FIGURES

For a more complete understanding of the present invention, including its features and advantages, reference is now made to the detailed description of the invention taken in conjunction with the accompanying drawing in which:

FIG. 1 is a diagram showing the structure of the system embodying the instant invention;

FIG. 2 shows a schematic of a portal web page according to the preferred embodiment of the instant invention;

FIG. 3 shows embodiments of independently functioning and independently selectable information display modules; and

FIG. 4 shows a schematic of a web page displaying detailed information from one of the selectable information modules displayed on the portal page.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

An embodiment of the present invention generally relates to an information service for providing shopping information, local information and advertising to residents within pre-defined geographical area through the use of connected computers. The embodiment includes a content display web page for displaying a plurality of pre-selected sets of information and advertising. In the past, consumers often had difficulties obtaining information about local shopping and dining offerings within close vicinity of their residence. This embodiment allows consumers to obtain this information from one source and also provides them with the ability of preview promotions, coupons, restaurant menus prior to physically visiting those locations.

Homeowners also have had issues in the past trying to communicate within their own neighborhood or subdivision. For example, garage sales, block parties and other activities can only be communicated with signs, flyers or notes posted on mailboxes. This embodiment helps resolve this problem by allowing neighbors to communicate events, sell and exchange goods through the system that is exclusively available to subscribed homeowners of that specific neighborhood.

Communication with local customers and potential local customers is also a common problem for small business owners. It is more so for local shops, cafes and restaurants that need to communicate within the near vicinity of their physical location in order to attract and inform their customer base. This embodiment solves that problem by providing that local framework through which local merchants can communicate with local consumers through informational articles, promotions, coupons and electronic stores.

An embodiment of the present invention is a method and a system for providing local shopping and advertising information from various information sources via a network of computers such as the Internet, wherein the provided information is selected and retrieved from the various sources based on pre-selected sets of parameters, the parameters being selectable by a system administrator.

An embodiment of the invention is an information system for providing shopping, news and advertising information to a user on a display terminal connected to a network of computers, which includes: an information source; a customizable database containing records having parameters for retrieval of information from the information source; and a computing device connected to the network that sends information to the display terminal. In the disclosed system, the parameters for information from the source can be pre-selected by the system administrator or the user.

The system allows for creation and storage of a plurality of parameters. The parameters are stored in a storage device and can be retrieved based on a user profile. In the disclosed system, the retrieved information is displayed in independently functioning display modules which are included in web pages.

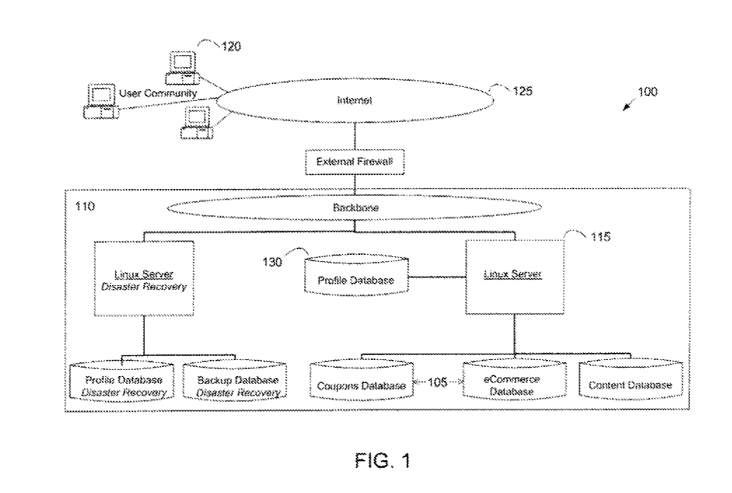

The elements of the information system 100 according to an embodiment of the invention are shown in FIG. 1. At the center of system 100 is a computing device 110 that hosts a website of the present embodiment. As known to those skilled in the art, the computing device 110 can be constituted by a plurality of processors acting as servers (e.g., application servers, database servers, etc.). Coupled to the computing device 110 is a plurality of information sources 105. These sources include internal proprietary databases, external databases and external online information services from which information can be gathered and passed onto the users through the computing device 110. Examples of external information sources include xml feeds from city websites, commercial partner websites, etc. The computing device 110 is coupled to the external information sources 105 through the Internet 125. Internal information sources 105 include, for example, a content database containing current retailer and restaurant information with their promotional offers.

In addition, a web server 115 is coupled to the computing device 110. The server 115 is used to select and retrieve information from the information sources 105 as is further described below. The retrieved, customized information is then displayed by an information display module provided in a portal web page for each user as will be described in detail below.

A separate user profile database 130 is also illustrated in FIG. 1. The profile database 130 is used to maintain user profiles for registered users. Each user profile includes a user name and password along with other pertinent information related to the user. A user accesses the website hosted on computing device 110 using the respective user name and password. However, the system also envisions other types of verification other than passwords. For example, the system could include a finger print scanner as well as an iris scanner to verify the user.

End users employ terminals 120 to connect to the computing device 110. In one embodiment, the connection between the end user terminals 120 and computing device 110 is made through the Internet 125. In addition, in this embodiment the connection between the end users and computing device 110 includes a firewall and other hardware and software security measures to ensure that unauthorized users (e.g. hackers) do not gain access to computing device 110. In this embodiment, the workstation 120 is a Personal Computer (PC) loaded with an Internet browser such as Mozilla™ Firefox™ or Microsoft™ Internet Explorer™. In alternative embodiments, the user can access the system 100 through the Internet 125 using any Internet ready device such as a web enabled Personal Digital Assistant (PDA) such as a Palm Pilot™, a cell phone or an interactive TV device.

The website hosted on computing device 110 is administered by a network administrator. In this embodiment, the internal portions of the website are made accessible only to authorized users. In addition, the authority to access the website is granted by the network administrator. In this system, the authorized users include authorized internal users and authorized external users. An authorized external user is an end user of the website who has been granted access to the website. For example, an authorized external user is an individual that has been selected by the administrator to have access to the website. In contrast, an authorized internal user is an employee, partner, associate or agent of the website administrator who is authorized to access the website. In this embodiment, the authorized internal users include, for example, employees of the corporation that administers the web site. An authorized internal user preferably has access to user profiles belonging to one or more authorized external users for the purpose of, for example, adding, deleting and modifying the data that is used to populate the display modules in the external users' portal web page. In this embodiment, at least one system administrator has access to all of the databases and can modify external user profiles and database records.

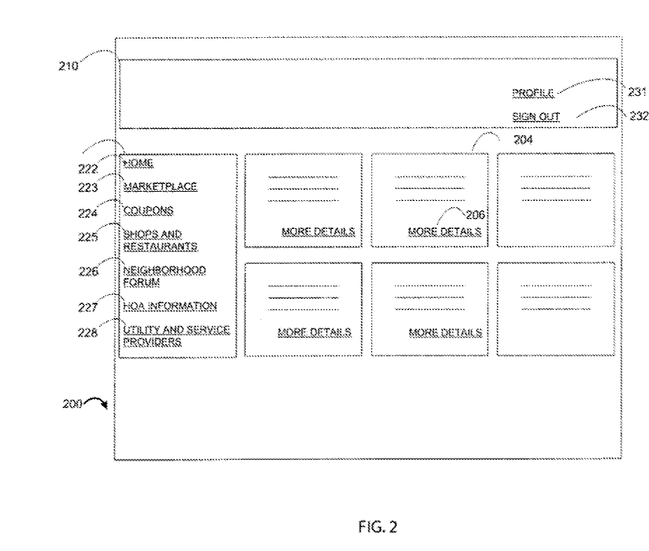

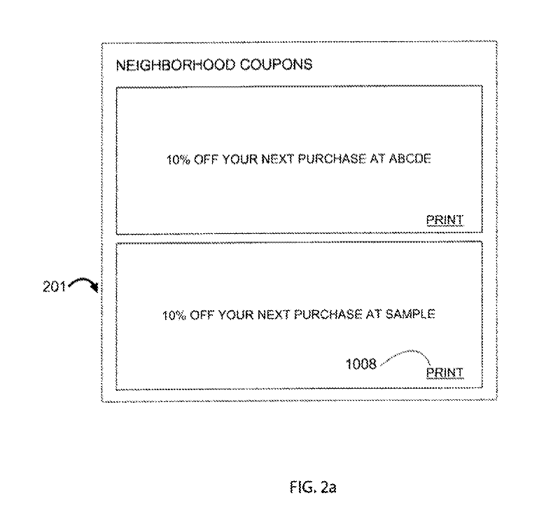

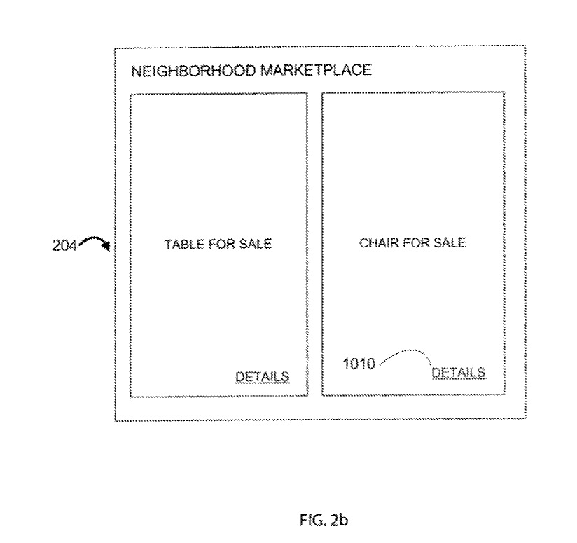

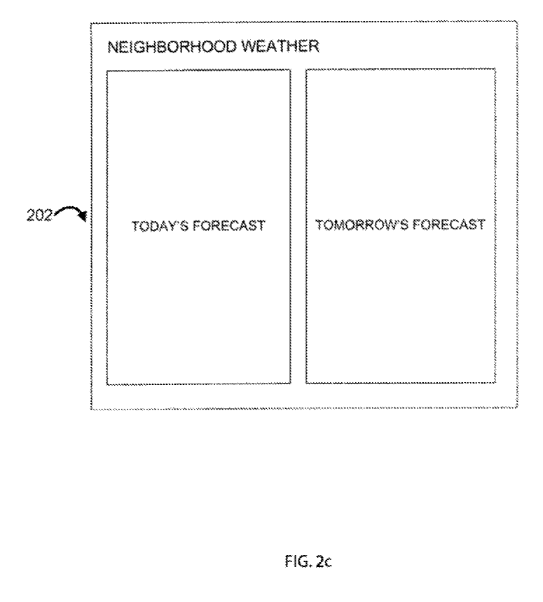

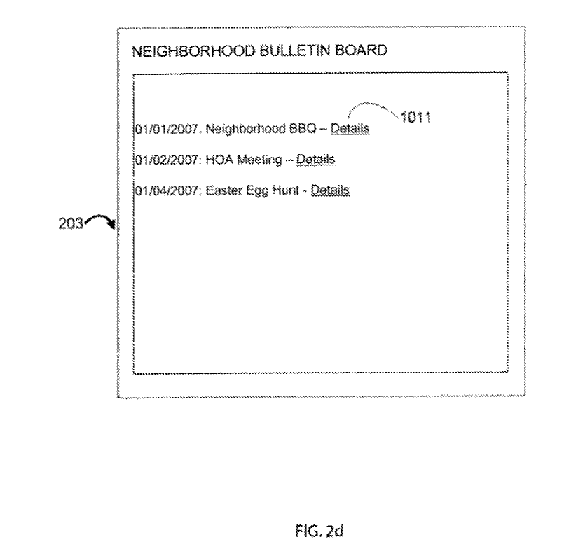

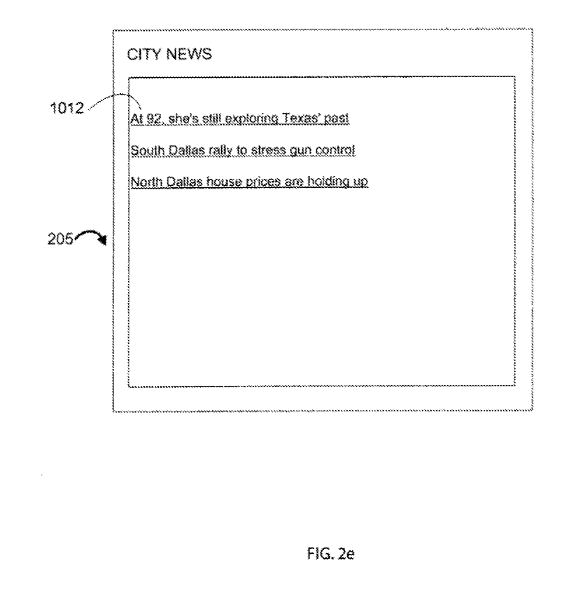

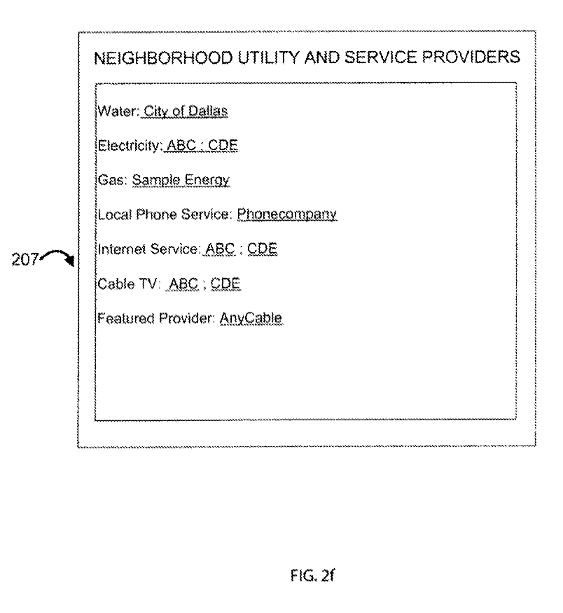

An embodiment of the instant invention will now be described with reference to FIG. 2. FIG. 2 shows a schematic diagram of a portal web page 200 according to this embodiment. When an authorized external user accesses the website hosted on the computing device 100 (shown in FIG. 1), portal web page 200 is displayed. In this embodiment, the web page 200 displays information such as city news, promotional coupons, weather forecasts and data (collectively referred to as “content”). The content may be provided from such sources as public or proprietary databases and other information services. The content is displayed within the portal web page 200. In addition, the displayed content may be customizable using the information contained in the user profiles within the profile database 130 (shown in FIG. 1).

In this embodiment, the content is displayed in separate display modules which are contained in portal web page 200. In addition, each of the display modules includes function buttons and/or links within a navigation area 220. Each function button and/or link within the navigation area 220 is associated with a respective feature of the present embodiment. For example, some or all of the modules may include a function button that, when clicked by a user, displays the content of the module in a graphical format. Moreover, each one of the display modules functions independently of the others so that modification of the content in one module will not change the content in the others.

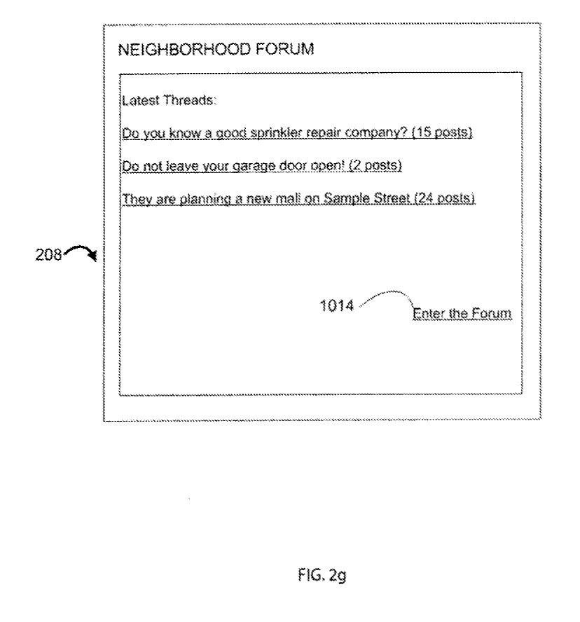

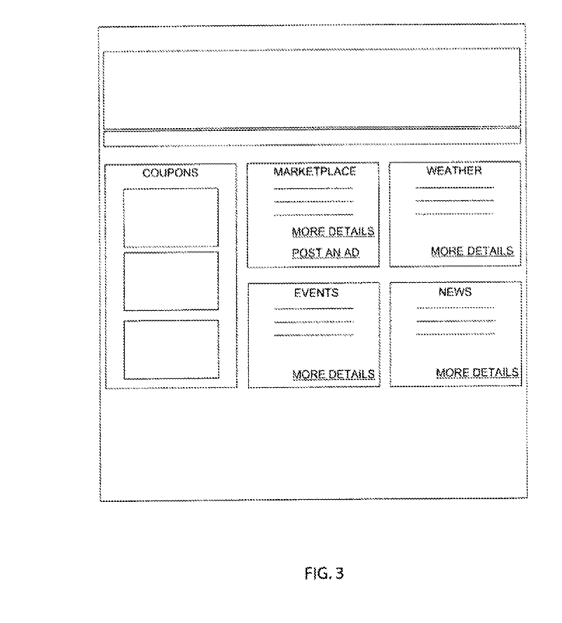

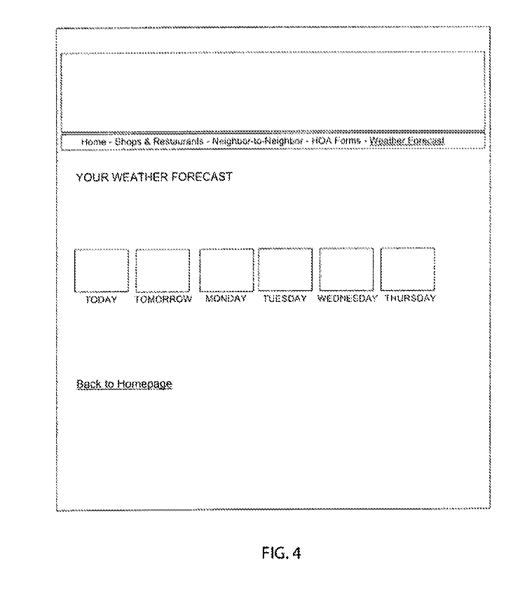

Further, a user's portal web page 200 may include all or some of the following display modules: Neighborhood Marketplace module 204 (shown in more detail in FIG. 4) which displays classified advertisement information submitted by other authorized users whose address is within the boundaries of the same subdivision or neighborhood as the viewing authorized user; Neighborhood; Coupons module 201 (shown in more detail in FIG. 3) which displays promotional coupons from a selected group of retailers and based on the user's address within the respective profile or by a city or zip code selected by the user; Weather Forecast module 202 (shown in more detail in FIGS. 5 and 11) which displays localized weather forecast information according to the authorized user's address or on the user's selected zip code or city; Neighborhood Bulletin Board module 203 (shown in more detail in FIG. 6) which displays announcements about subdivision, neighborhood or homeowners' association activity according to the authorized user's address, City News module 205 (shown in more detail in FIG. 7) which displays news headlines from one or more information sources according to the city name within the authorized user's profile or the user's selected zip code or city; Local Utility and Service Providers module 207 (shown in more detail in FIG. 8) which displays preselected hyper-text links to the websites of one or more of the utility and service companies that serve the authorized user's address, according to the user's profile information; Neighborhood Forum module 208 (shown in more detail in FIG. 9) which displays one or more items posted by authorized users whose address is within the boundaries of the same subdivision or neighborhood as the viewing authorized user, however, this page also allows the user post messages.

In this embodiment, each of these modules include a Print button or hyper-text link 1008 (shown in FIG. 3), which allows the user to access a printer friendly version of the item or items displayed in that module. In addition, each of the modules may also include a Details button or hyper-text link 223 and/or an embedded hyper-text link 1012 (shown in FIG. 7) that is part of the displayed content items. Clicking on the Details button 223 or the hyper-text link 1012 allows the user to view a page containing more detailed information about the item or items displayed in the module.

In addition, the navigation area 220 also includes: Home 222 by which authorized users can view their corresponding portal page; Shops and Restaurants 225 by which authorized users can view a page displaying shop and restaurant information preselected by the administrator; Home Owners Association (HOA) Information 227 by which authorized users can view a page displaying information about their homeowners association as well as one or more hyper-text links to the association's rules and regulations, forms and official documents if the authorized user's neighborhood is governed by such an entity.

Portal web page 200 also includes top navigation area 210 including the following functional modules: Sign Out 232 that allows the authorized user to log out of the system; Profile 231 by which the authorized user can view a page displaying their profile information.

Referring now to FIG. 3, Neighborhood Coupons 201 will now be described. Neighborhood Coupons 201 displays one or more graphical coupons from a selected group of retailers and based on the user's address, recent activity or other user related information. When an authorized user clicks on a displayed coupon, a page is displayed with a printer friendly version of the coupon and a Print hyper-text link 1008. However, in addition, this embodiment envisions that these coupons can also be transmitted to the user's account or loyalty rewards account.

Referring now to FIG. 4, Neighborhood Marketplace 204 will now be described. Neighborhood Marketplace 204 displays one or more classified advertisement items posted by authorized users whose address is within the boundaries of the same subdivision or neighborhood as the viewing authorized user. By clicking on the Details hyper-text link 1010, the authorized user can view a page displaying all the classified advertisements that correspond to their subdivision or neighborhood based on the user's profile or related information.

Referring now to FIG. 5, Neighborhood Weather 202 will now be described. In this embodiment, today's forecast is shown on the right, while tomorrow's forecast is shown on the left. However, as any skilled person in the art would know, the weather can be shown in a variety of methods.

Referring now to FIG. 6, Neighborhood Bulletin Board 203 will now be described. In this embodiment, the Neighborhood Bulletin Board 203 displays announcements about subdivision, neighborhood or homeowners' association activity according to the authorized user's address. By clicking on the hyper-text links 223, the authorized user can view a page displaying the full text of that specific announcement.

Referring now to FIG. 7, City News 205 will now be described. In this embodiment, the City News 205 webpage displays news headlines from one or more information sources according to the city name or zip code within the authorized user's profile. By clicking on the embedded hyper-text link 1012, the authorized user can view a page displaying the full text corresponding to the headline selected. This information may also be displayed on a different website. In addition, the user may want to change the city or zip code to see news from other locations.

Referring now to FIG. 8, Neighborhood Utility and Service Providers 207 will now be described. In this embodiment, the page includes listings for the water department, the electricity provider, the gas provider, the local phone service provider, the Internet service provider, the cable TV provider and a featured provider. However, many other configurations of this page are envisioned within the spirit of the present invention.

Referring now to FIG. 9, Neighborhood Forums 208 will now be described. In this embodiment, the Neighborhood Forums 208 webpage displays a one or more items posted by authorized users whose address is within the boundaries of the same subdivision or neighborhood as the viewing authorized user. By clicking on the Enter the Forum hyper-text link 1014, the authorized user is presented with a page that includes an online message board that displays a framework within which the authorized user can read messages from other authorized users and post messages that may be displayed to other authorized users.

Referring now to FIG. 10, another configuration of a main page is shown. In this embodiment, a coupons portion is shown on the left side of the page while a marketplace portion, a weather portion, an events portion and a news portion are shown a center and right side of the webpage.

Referring now to FIG. 11, another configuration of a weather forecast is shown. In this embodiment, a six day forecast is shown along with a menu toolbar shown above the forecast.

Although this invention has been described with reference to illustrative embodiments, this description is not intended to limit the scope of the invention. Various modifications and combinations of the illustrative embodiments as well as other embodiments of the invention will be apparent to persons skilled in the art upon reference to the description. For example, the web pages of the present invention can be modified to include other geographic regions and/or other configurations not displayed in the figures. In addition, the individual modules can be represented as groupings of information instead of just individual modules. Many other variations exist of the web pages. It is therefore intended that the appended claims accomplish any such modifications or embodiments.

We claim:

1. An information system comprising:
a communications network;
a database server connected to the communication network, wherein the database server stores a plurality of records, each of the records having a plurality of searching parameters;
a plurality of user stations connected to the communications network, wherein each of the user stations allow an authorized user to access the database server;
at least one searchable information source connected to the communications network, wherein the at least one information source contains data that is searchable using at least one of the searching parameters and wherein only a portion of the records may be accessed by an authorized user and wherein the portion of records includes records created and stored by the authorized user.

2. The information system of claim 1, further comprising an information server for transmitting information to the plurality of user stations.

3. The information system of claim 2, wherein the transmitted information includes results from a search of the at least one searchable information source based on the at least one searching parameter.

4. The information system of claim 3, wherein the plurality of user stations include a display terminal for displaying the transmitted information.

5. The information system of claim 4, wherein each of the records in the portion of records is stored under a respective unique designation.

6. The information system of claim 4, wherein the transmitted information is displayed in an information module on a display terminal.

7. A system for displaying information comprising:
a plurality of searchable information sources containing searchable data;
a database server containing a database, wherein the database includes a plurality of records and wherein each record includes a plurality of searching parameters having a unique designation and wherein each record can be retrieved by its respective unique designation and used to search at least one of the plurality of searchable information sources to obtain a search result;
an information server connected to the database server and the plurality of searchable information sources, wherein the information server is connected to a communications network and is capable of transmitting a page containing search results to a display terminal through the communications network;
wherein the page includes a plurality of independently modifiable information display modules for displaying information based on the search results,
wherein at least one of the information display modules is associated with a respective menu for displaying a plurality of the unique designations as selectable options so that a user may select one of the unique designations to have a search performed based on the searching parameters in the record assigned thereto to obtain a search result to modify based on the information displayed in the associated display module.

8. A system according to claim 7, wherein the page is a web page.

9. A system according to claim 8, wherein the web page includes automatically updateable information display modules.

10. A system according to claim 7, wherein the modules include a plurality associated selectable functional buttons.

11. A system according to claim 10, wherein at least one of the buttons activates a function for expanding the scope of the information displayed in the modules.

12. A system according to claim 11, wherein the database further includes records containing parameters uniquely associated with an individual user's geographical residence location, the parameters being used to customize the contents of a page for the individual user.

13. A system for displaying information in a web page comprising:
a plurality of information sources;
a database containing custom records, each custom record containing at least one search parameter for searching at least one of the plurality of information sources,
an information server operatively connected to a plurality of user stations via a network to receive requests for information from each one of the user stations and transmit information to each one of the user stations, each one of the user stations being associated with a respective display terminal for displaying a web page;
wherein the information server may transmit code to each of the plurality of user stations to display a portal web page via a respective display terminal associated with each of the plurality of user stations;
wherein the portal web page including a plurality of information display modules each for displaying information to a user;
wherein the information is based on searching at least one of the information sources using at least one search parameter;
wherein the plurality of information display modules displaying information based on search parameters in custom records included:
a module for displaying information about weather,
a module for displaying information about discounts at local retail facilities,
a module for displaying information about items for sale by individuals within close geographical proximity to the user,
a module for displaying information about homeowners' association rules and regulations,
a module for displaying local news,
a module for displaying utility provider hyperlinks,
a module for displaying utility provider advertisements, a module for displaying information about local retailers, a module for displaying information about local restaurants,
a module for displaying information about city and community services,
a module for displaying a calendar of local events,
a module for displaying a message and discussion board,
a module for displaying advertisement and promotion subscription forms and
a module providing access to the authorized user's profile information.

14. The system of claim 13 for sending email to residents wherein the email includes at least one of the following: information, special offers and discounts offered by local merchants, retailers and service provides.

15. The system of claim 14 wherein the email is uniquely associated with the recipients' geographical location.

17. The system of claim 13 further comprising a subscription-based electronic newsletter system based on the geographical location of the subscriber

18. The system of claim 17 wherein the newsletter includes at least of the following: informational articles, promotions, coupons from local merchants, retailers and service providers as well as links to websites and electronic stores belonging to those entities.
